(19) United States
(12) Patent Application Publication
(10) Pub. No.: US 2025/0030901 A1
(43) Pub. Date: Jan. 23, 2025

(54) IMAGE PROCESSING METHOD AND APPARATUS, DEVICE, AND MEDIUM

(71) Applicant: Beijing Zitiao Network Technology Co., Ltd., Beijing (CN)

(72) Inventor: Dichuan CHEN, Beijing (CN)

(21) Appl. No.: 18/715,060

(22) PCT Filed: Nov. 25, 2022
(86) PCT No.: PCT/CN2022/134247

§ 371 Date: May 30, 2024

(30) Foreign Application Priority Data
Nov. 30, 2021 (CN) 202111450052.5

(51) Int. Cl. H04N 21/2187; H04N 21/431; H04N 21/858

(52) U.S. Cl. CPC H04N 21/2187; H04N 21/4316; H04N 21/8586

(57) ABSTRACT

Embodiments of the present disclosure relate to an image processing method and apparatus, a device, and a medium. The method includes: obtaining, in response to an operation of adding a sticker image, a uniform resource locator (URL) corresponding to the sticker image; determining a target frame corresponding to the sticker image in a live video stream; obtaining a target frame identifier of the target frame; determining display information of the sticker image in the target frame; and sending a sticker addition information, wherein the sticker addition information includes the target frame identifier, the URL, and the display information

### CROSS-REFERENCE TO RELATED APPLICATIONS

The present application is the U.S. National Stage of International Application No. PCT/CN2022/134247, filed on Nov. 22, 2022, which is based on and claims priority to Chinese Application No. 202111450052.5, filed on Nov. 30, 2021, which are incorporated herein by reference in their entireties.

### TECHNICAL FIELD

The present disclosure relates to the field of communication technologies, and in particular, to an image processing method and apparatus, a device, and a medium.

### BACKGROUND ART

With the rise of short video applications, features of short videos are becoming increasingly diverse. For example, a streamer user can set a sticker image in a live streaming interface during live streaming. A selected sticker image may be displayed in a live streaming room of the streamer and synchronously displayed in a viewing interface of a viewing client.

In the related art, a solution for displaying a sticker image set by a streamer in a viewing program on a viewing client consumes a large amount of computing resources, and a fusion process may lead to live streaming freezing on a live streaming client, and may also affect efficiency of displaying the sticker image on the viewing client.

### SUMMARY OF THE INVENTION

An embodiment of the present disclosure provides an image processing method. The method includes: obtaining, in response to an operation of adding a sticker image on a live streaming client, a uniform resource locator (URL) corresponding to the sticker image; determining a live streaming associated frame of the sticker image in a corresponding live video stream, and obtaining an associated frame identifier of the live streaming associated frame; determining display position information of the sticker image in the live streaming associated frame; and sending a sticker addition message to at least one viewing client corresponding to the live streaming client, where the sticker addition message includes the associated frame identifier, the URL, and the display position information.

An embodiment of the present disclosure provides an image processing method. The method includes: extracting, in response to a sticker addition message sent by a server, an associated frame identifier, a URL, and display position information from the sticker addition message; obtaining a sticker image based on the URL, and determining a corresponding viewing associated frame in a viewing video stream based on the associated frame identifier; and displaying the sticker image in the viewing associated frame based on the display position information.

An embodiment of the present disclosure further provides an image processing apparatus. The apparatus includes: a first obtaining module configured to obtain, in response to an operation of adding a sticker image on a live streaming client, a uniform resource locator (URL) corresponding to the sticker image; a second obtaining module configured to determine a live streaming associated frame of the sticker image in a corresponding live video stream, and obtain an associated frame identifier of the live streaming associated frame; a first determining module configured to determine display position information of the sticker image in the live streaming associated frame; and a sending module configured to send a sticker addition message to at least one viewing client corresponding to the live streaming client, where the sticker addition message includes the associated frame identifier, the URL, and the display position information.

An embodiment of the present disclosure further provides an image processing apparatus. The apparatus includes: an extraction module configured to extract, in response to a sticker addition message sent by a server, an associated frame identifier, a URL, and display position information from the sticker addition message; a second determining module configured to obtain a sticker image based on the URL, and determine a corresponding viewing associated frame in a viewing video stream based on the associated frame identifier; and a display module configured to display the sticker image in the viewing associated frame based on the display position information.

An embodiment of the present disclosure further provides an electronic device. The electronic device includes: a processor; and a memory configured to store instructions executable by the processor, where the processor is configured to read the executable instructions from the memory, and execute the instructions to implement the image processing method provided in the embodiments of the present disclosure.

An embodiment of the present disclosure further provides a computer-readable storage medium having a computer program stored thereon, where the computer program is configured to perform the image processing method provided in the embodiments of the present disclosure.

An embodiment of the present disclosure further provides a computer program product, where instrucions in the computer program product, when executed by a processor, causes the image processing method provided in the embodiments of the present disclosure to be implemented.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic diagram of an image processing scenario in the related art according to an embodiment of the present disclosure;

FIG. 2 is a schematic diagram of an image processing method according to an embodiment of the present disclosure;

FIG. 3 is a schematic diagram of another image processing method according to an embodiment of the present disclosure;

FIG. 4 is a schematic diagram of a scenario of determining display position information according to an embodiment of the present disclosure;

FIG. 5 is a schematic diagram of another image processing method according to an embodiment of the present disclosure;

FIG. 6 is a schematic diagram of another scenario of determining display position information according to an embodiment of the present disclosure;

FIG. 7 is a schematic diagram of another image processing method according to an embodiment of the present disclosure;

FIG. 8 is a schematic diagram of another image processing method according to an embodiment of the present disclosure;

FIG. 9 is a schematic diagram of another image processing method according to an embodiment of the present disclosure;

FIG. 10 is a schematic diagram of a display scenario of a sticker image according to an embodiment of the present disclosure;

FIG. 11 is a schematic diagram of a structure of an image processing apparatus according to an embodiment of the present disclosure;

FIG. 12 is a schematic diagram of a structure of another image processing apparatus according to an embodiment of the present disclosure; and

FIG. 13 is a schematic diagram of a structure of an electronic device according to an embodiment of the present disclosure.

### DETAILED DESCRIPTION OF THE INVENTION

Embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

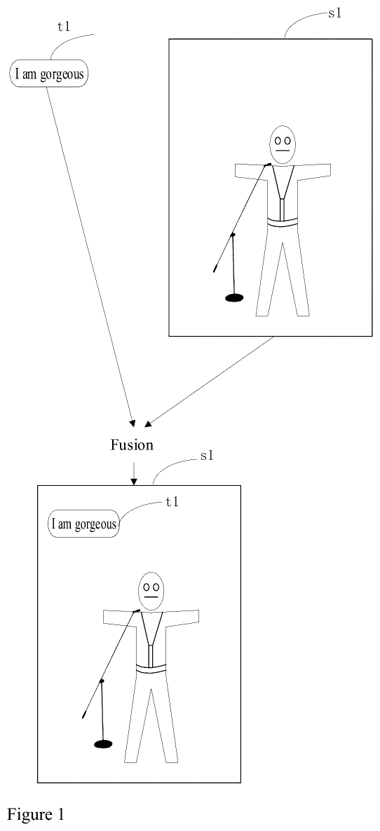

In the related art, a streamer user adds a sticker during live streaming. As shown in FIG. 1, a streamer user sets a sticker image t1 “I am gorgeous” on a live streaming interface. In order to transmit the sticker image to a viewing client, with continued reference to FIG. 1, it is necessary to fuse the sticker image t1 and a corresponding live streaming video frame s1 in a live video stream on a streamer client, and send a fused live video stream to the viewing client, so as to ensure that the corresponding sticker image can be viewed on the viewing client while a live streaming video is being watched.

In the related art, a solution for displaying a sticker image set by a streamer in a viewing program on a viewing client consumes a large amount of computing resources, and a fusion process may lead to live streaming freezing on a live streaming client, and may also affect efficiency of displaying the sticker image on the viewing client.

In order to solve the above problems, the present disclosure provides an image processing method that can send a sticker image without fusing the sticker image and a video frame. In this method, the sticker image is transmitted in the form of a uniform resource locator (URL), thereby eliminating the consumption of computing power for fusion, avoiding the live streaming freezing on the live streaming client, and improving the transmission efficiency of the sticker image.

In order to comprehensively describe the image processing method in the embodiments of the present disclosure, the image processing method in the embodiments of the present disclosure is separately described below on a server side and a viewing client side.

The description on the server side is first provided.

An embodiment of the present disclosure provides an image processing method, which is described below in connection with a specific embodiment.

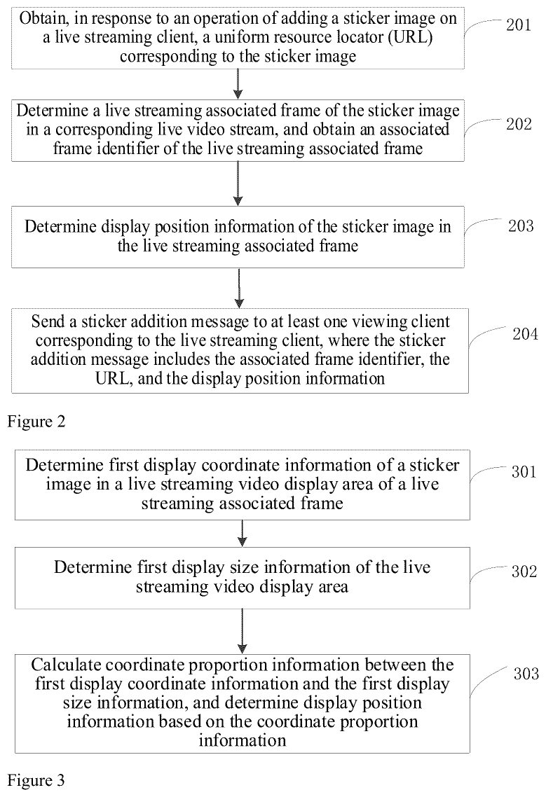

FIG. 2 is a schematic flowchart of an image processing method according to an embodiment of the present disclosure. The method may be performed by an image processing apparatus, which may be implemented using software and/or hardware and may generally be integrated into an electronic device. As shown in FIG. 2, the method includes the following steps.

Step 201: Obtain, in response to an operation of adding a sticker image on a live streaming client, a uniform resource locator (URL) corresponding to the sticker image.

The operation of adding the sticker image on the live streaming client may be performed by selecting a corresponding sticker image and dragging it to a corresponding live streaming interface, or may be performed by selecting the corresponding sticker image with voice.

In this embodiment, in response to the operation of adding the sticker image on the live streaming client, the uniform resource locator (URL) corresponding to the sticker image is obtained, so as to further obtain the corresponding sticker image based on the URL.

Step 202: Determine a live streaming associated frame of the sticker image in a corresponding live video stream, and obtain an associated frame identifier of the live streaming associated frame.

In this embodiment, the corresponding sticker image may be added to each frame in the live video stream, or the corresponding sticker image may be added to some of the video frames. In order to determine the live streaming associated video frame to which the sticker image is added, in this embodiment, after the live streaming associated frame of the sticker image in the corresponding live video stream is determined, the associated frame identifier corresponding to the live streaming associated frame is determined, where the associated frame identifier may be image feature information of the corresponding live streaming associated frame, serial number information of the live streaming associated frame in the corresponding live video stream, or the like.

It should be noted that a method for determining the live streaming associated frame of the sticker image in the corresponding live video stream varies in different application scenarios. An example is as follows.

In an embodiment of the present disclosure, whether the sticker image is contained in each live streaming video frame in the live video stream is detected. For example, image feature information of the sticker image is obtained, whether the image feature information of the sticker image is contained in each live streaming video frame is determined, and a live streaming video frame that contains the image feature information of the sticker image is determined as the live streaming associated video frame, and a first video frame identifier of the associated video frame may be further obtained as the associated frame identifier.

In another embodiment of the present disclosure, an addition time of the sticker image is obtained, a playback time of each video frame in the live video stream is obtained, and whether there is a deletion time of the sticker image is further detected. If there is a deletion time, a live streaming video frame having a playback time matching the deletion time is determined as a last live streaming associated frame, a live streaming video frame having a playback time matching the addition time is determined as a first live streaming associated frame, and all live streaming video frames between the first live streaming associated frame and the last live streaming associated frame are determined as live streaming associated frames. If no deletion time of the sticker image is detected, the first live streaming associated frame with the playback time matching the addition time and all live streaming video frames after the first live streaming associated frame are determined as live streaming associated frames, and associated frame identifiers of the live streaming associated frames are further determined.

Step 203: Determine display position information of the sticker image in the live streaming associated frame.

In this embodiment, the display position information of the sticker image in the corresponding live streaming associated frame is determined, so as to determine an addition position of the sticker image on a corresponding viewing client based on the display position information.

In different application scenarios, a method for determining the display position information of the sticker image in the corresponding live streaming associated frame varies.

In some embodiments, as shown in FIG. 3, determining the display position information of the sticker image in the corresponding live streaming associated frame includes the following steps.

Step 301: Determine first display coordinate information of the sticker image in a live streaming video display area of the live streaming associated frame.

The first display coordinate information may include X-axis coordinate information and Y-axis coordinate information, where any point in the live streaming video display area may be defined as an origin of coordinates, and first display coordinate information of a center point of the sticker image or any other reference point relative to the coordinate origin may be determined.

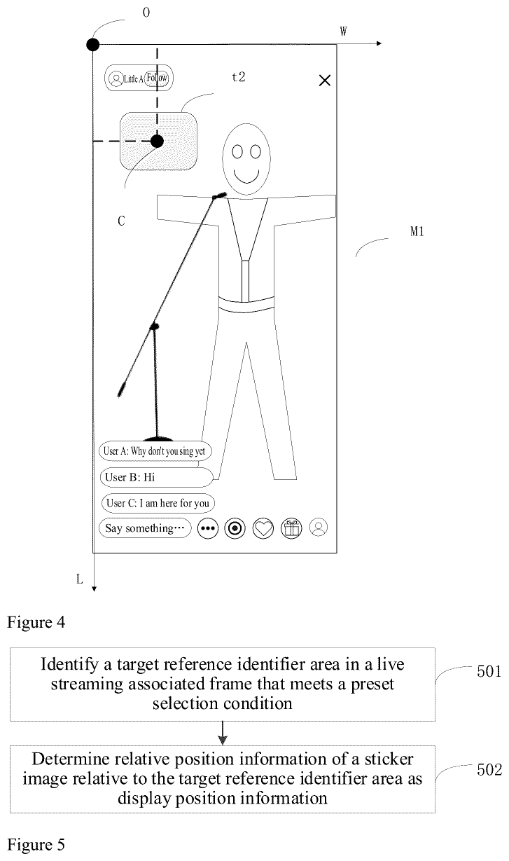

For example, as shown in FIG. 4, a coordinate system is constructed in a live streaming video display area M1, an upper left corner of the live streaming video display area is defined as an origin O of coordinates, and further a coordinate position of a center point of a sticker image t2 relative to the origin of coordinates is determined as first display coordinate information C.

Step 302: Determine first display size information of the live streaming video display area.

In this embodiment, the first display size information of the live streaming video display area of the live streaming video client is determined. With continued reference to FIG. 4, the first display size information of the live streaming video display area includes length information L and width information W and the like of the live streaming video display area, and the live streaming video display area may be understood as a display area of a live streaming video picture.

Step 303: Calculate coordinate proportion information between the first display coordinate information and the first display size information, and determine the display position information based on the coordinate proportion information.

In this embodiment, the coordinate proportion information between the first display coordinate information and the first display size information is calculated. For example, when the first display coordinate information includes X-axis coordinate information and Y-axis coordinate information, the coordinate proportion information includes a ratio of the X-axis coordinate information to a length of the first display size information and a ratio of the Y-axis coordinate information to a width of the first display size information, and the display position information is determined based on the length ratio and the width ratio.

Therefore, the coordinate proportion information of the sticker image in the live streaming associated frame is delivered to the viewing client, such that the display coordinate proportion of the sticker image on the live streaming client can be restored on the viewing client based on the coordinate proportion information, which ensures the display consistency of the sticker image between the viewing client and the live streaming client. In some other embodiments, since the live streaming associated frame in the live video stream is generated based on a size standard of a video frame, a size of the live streaming associated frame is not limited by the size of the display area of the live streaming client, which facilitates subsequent display restoration of the sticker image in a viewing associated frame that is generated on the viewing client according to the size standard of the video frame. Therefore, in this embodiment, after the first display coordinate information of the sticker image in the live streaming video display area of the live streaming video client is determined, the coordinate proportion information between the first display coordinate information and the video frame size information is determined, where a method for calculating the coordinate proportion information is similar to the calculation method of the coordinate proportion information in the above embodiment, and will not be repeated here. Further, the display position information of the sticker image is determined based on the coordinate proportion information. In some other embodiments, as shown in FIG. 5, determining the display position information of the sticker image in the live streaming associated frame includes the following steps.

Step 501: Identify a target reference identifier area in the live streaming associated frame that meets a preset selection condition.

A target reference identifier in the live streaming associated frame that meets the preset selection condition may be a video element fixedly displayed in the live streaming associated frame or an identifier in the live streaming associated frame that indicates a distinctive feature of a live stream, such as a streamer profile photo identifier, a follow control identifier, or a comment input box identifier; or it may be an identifier in the live streaming associated frame that indicates a distinctive feature of a live stream, such as a shopping cart identifier or a windmill identifier.

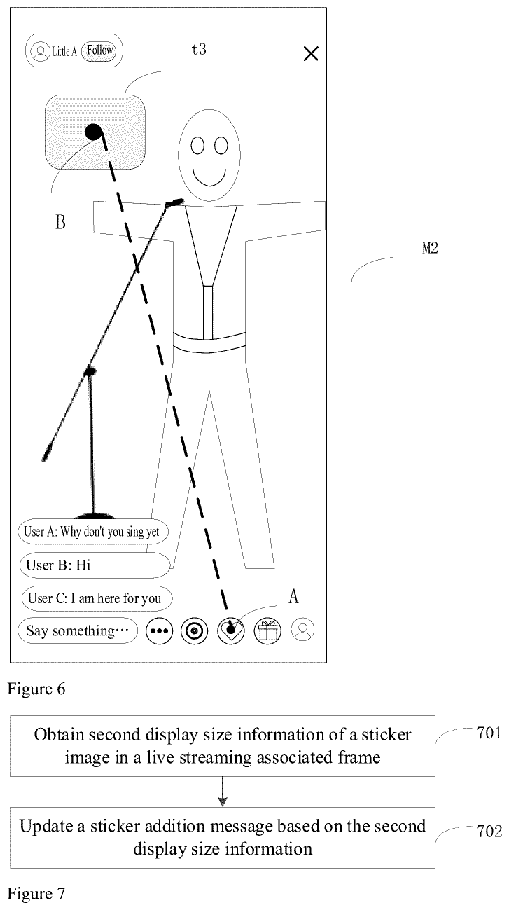

The preset selection condition vary in different application scenarios. In some embodiments, a relatively fixed menu control in the live streaming associated frame may be determined as the target reference identifier area. As shown in FIG. 6, a relatively fixed reference object image may be a “favorite” control, etc. In FIG. 6, a live streaming associated frame is displayed in a live streaming video display area M2, and t3 denotes the sticker image.

In some other embodiments, if a background of the live streaming associated frame contains an entity, for example, an entity such as a “sofa” or a “cabinet” with a relatively fixed position, the corresponding entity may be determined as a target reference object.

Step 502: Determine relative position information of the sticker image relative to the target reference identifier area as the display position information.

In this embodiment, since the target reference identifier area is a relatively fixed image element in a background of the live streaming video frame, such as a “sofa” in the background or a “favorite” control, the relative position information of the sticker image relative to the target reference identifier area is determined, and based on determining the relative position information as the display position information, the addition position of the sticker image may be restored in a relatively accurate manner on the viewing client.

A coordinate system may be constructed by taking any point in the target reference identifier area as an origin of coordinates, and a position of any point in the sticker image in the coordinate system is determined as the relative position information.

For example, with continued reference to FIG. 6, when the target reference object is the “favorite” control, a point A on the “favorite” control is determined as an origin of coordinates. The coordinate system is constructed based on the point A, and coordinates of a center point B of the sticker image relative to A are determined as the relative position information.

Step 204: Send a sticker addition message to at least one viewing client corresponding to the live streaming client, where the sticker addition message includes the associated frame identifier, the URL, and the display position information.

In this embodiment, a current viewing user corresponding to the live streaming client may be obtained, and a viewing client corresponding to the current viewing user may be determined. In order to synchronize the sticker information to a viewing client, a carried sticker addition message is sent to the at least one viewing client corresponding to the live streaming client, where the sticker addition message includes the associated frame identifier, the URL, and the display position information.

Therefore, the relative position information of the sticker image relative to the reference identifier area in the live streaming associated frame is delivered to the viewing client, such that the display position of the sticker image on the live streaming client can be restored on the viewing client based on the relative position information, which ensures the display consistency of the sticker image between the viewing client and the live streaming client.

Therefore, in this embodiment, the sticker image can be transmitted simply by sending the URL of the sticker image, without a need to fuse the sticker image with the live streaming video frame, which reduces transmission resource consumption and improves efficiency of sending the sticker image. In addition, in order to ensure that the display effect of the sticker image on the viewing client is the same as that on the live streaming client, the display position information of the sticker image is also sent to the viewing client.

In conclusion, according to the image processing method in this embodiment of the present disclosure, in response to the operation of adding the sticker image on the live streaming client, the uniform resource locator (URL) corresponding to the sticker image is obtained, the associated frame identifier of the sticker image in the corresponding live video stream is determined, the display position information of the sticker image in the corresponding live streaming associated frame is determined, and further, the carried sticker addition message is sent to the at least one viewing client corresponding to the live streaming client, where the sticker addition message includes the associated frame identifier, the URL, and the display position information. Therefore, the sticker image added to the live streaming room is transmitted based on the uniform resource locator (URL), without a need for fusion calculations of related live streaming video frames and the sticker image, which ensures the smoothness of live streaming, and improves the transmission efficiency of the sticker image.

Based on the above embodiment, in order to further restore the display effect of the sticker image on the live streaming client, second display size information of the sticker image may also be restored on the viewing client.

In this embodiment, as shown in FIG. 7, before the sticker addition message is sent to the at least one viewing client corresponding to the live streaming client, the method further includes the following steps.

Step 701: Obtain second display size information of the sticker image in the live streaming associated frame.

In some embodiments, the second display size information may include actual length information and width information of the sticker image. In this embodiment, if size information of the live streaming video display area is known, the second display size information of the sticker image may be determined based on a ratio of the sticker image to the live streaming video display area.

In some other embodiments, a first size ratio of the sticker image to the live streaming video display area may be calculated, and further, a second size ratio of the live streaming video display area to the live streaming associated video frame in the live video stream may be calculated, and original size information of the sticker image in the live streaming video display area may be obtained. Based on the product of the original size information, the first size ratio, and the second size ratio, the second display size information of the sticker image is determined.

The second display size information is size information of the sticker image relative to the live streaming associated video frame, and since the live streaming associated video frame has the same size as the corresponding viewing video frame, an isometric scaling display effect of the sticker image can be achieved on the corresponding viewing client based on the second display size information in this embodiment, which further improves the display effect consistency of the sticker image between the viewing client and the live streaming client.

Step 702: Update the sticker addition message based on the second display size information.

In this embodiment, the sticker addition message is updated based on the second display size information, i.e., the second display size information is also in the sticker addition message and transmitted to the corresponding viewing client, in order to facilitate consistent display of the sticker image on the viewing client.

In conclusion, according to the image processing method in this embodiment of the present disclosure, the second display size information of the sticker image in the corresponding live streaming associated frame is further obtained, the sticker addition message is updated based on the second display size information, so that on the premise of ensuring the smoothness of the live streaming client when the sticker image is added, the display consistency of the sticker image between the viewing client and the live streaming client is further achieved.

Then, the following describes an image processing method according to an embodiment of the present disclosure on the viewing client.

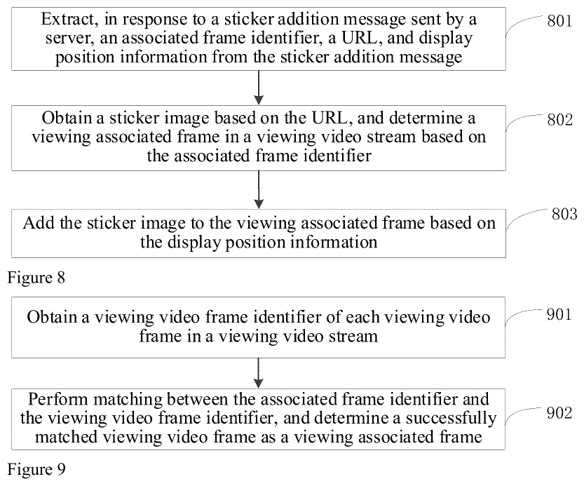

FIG. 8 is a flowchart of an image processing method according to another embodiment of the present disclosure. As shown in FIG. 8, the method includes the following steps.

Step 801: Extract, in response to a sticker addition message sent by a server, an associated frame identifier, a URL, and display position information from the sticker addition message.

Step 802: Obtain a sticker image based on the URL, and determine a viewing associated frame in a viewing video stream based on the associated frame identifier.

In this embodiment, in response to the sticker addition message sent by the server, the associated frame identifier, the URL, and the display position information are extracted from the sticker addition message, so as to add the sticker image based on the extracted information.

In this embodiment, the sticker image is obtained based on the URL, where a storage location of the sticker image may be a server or another storage location, and the corresponding sticker image is read at the corresponding storage location based on the URL.

Further, in this embodiment, in order to ensure that a viewing video frame in which the sticker image is displayed is consistent with the live streaming video frame in which the sticker image is displayed, the viewing associated frame in the viewing video stream is determined based on the associated frame identifier.

In different application scenarios, a method for determining the viewing video frame in the viewing video stream based on the associated frame identifier varies. An example is as follows.

In an embodiment of the present disclosure, as shown in FIG. 9, determining a corresponding associated frame based on the associated frame identifier includes the following steps.

Step 901: Obtain a viewing video frame identifier of each viewing video frame in the viewing video stream.

In this embodiment, the viewing video frame identifier of each viewing video frame in the viewing video stream is obtained, for example, video frame code of each viewing video frame is obtained, or, for another example, an image feature of each viewing video frame is obtained, and so on.

Step 902: Perform matching between the associated frame identifier and the viewing video frame identifier, and determine a successfully matched viewing video frame as the viewing associated frame.

It can be understood that the associated frame identifier is an identifier of a live streaming associated video frame in which the sticker image is displayed. Therefore, matching is performed between the associated frame identifier and the viewing video frame identifier, and then the successfully matched viewing video frame is determined as a video frame in which the sticker image is displayed on the viewing client, so that the successfully matched viewing video frame is determined as the viewing associated frame.

In another embodiment of the present disclosure, a time period of the live streaming associated video frame in which the sticker image is displayed is determined, and all viewing video frames corresponding to the time period are determined as viewing associated frames.

Step 803: Add the sticker image to the corresponding viewing associated frame based on the display position information.

After the viewing associated frame and the sticker image are determined, the sticker image is added to the corresponding viewing associated frame based on the display position information.

It should be noted that the display position information varies in different application scenarios, so that a method for adding the sticker image to the corresponding viewing associated frame based on the display position information varies. An example is as follows.

In an embodiment of the present disclosure, if the display position information includes coordinate proportion information between the sticker image and a corresponding live streaming video display area, adding the sticker image to the corresponding viewing associated frame based on the display position information includes: obtaining third display size information of a viewing video display area of the viewing associated frame, where the third display size information may include a length value and a width value of the viewing video display area, and the viewing video display area is related to a display area of the viewing client.

The coordinate proportion information is coordinate proportion information between coordinates of the sticker image and a size of the corresponding live streaming video display area. In order to restore the display effect of the sticker image in the live video stream, it is necessary to ensure that a display position in the viewing associated frame is consistent with a display position in the live streaming associated frame, so that a product value of the third display size information and the coordinate proportion information is calculated to obtain second display coordinate information. For example, when a length of the third size information is a1, width information of the third size information is b1, and a ratio is m, (a1m, b1m) is used as the second display coordinate information, so that the sticker image is displayed at the second display coordinate position information in the corresponding viewing video frame.

In another embodiment of the present disclosure, if the display position information is relative position information of the sticker image relative to a target reference identifier area in the live streaming associated frame that meets a preset selection condition, the target reference identifier area in the corresponding viewing video frame is identified, and based on the relative position information, the display position information of the sticker image in the corresponding viewing video frame is determined. It should be noted that the relative position information is determined based on the live streaming associated frame, and since the live streaming associated frame and the viewing video frame have a video frame size that is generated based on a unified size standard, the determination of a display position of the sticker image in the viewing live streaming video frame based on the relative position information is not affected by a size of the display area of the viewing client, and a size of the sticker image and a display size of the viewing associated frame are uniformly adjusted based on the size of the display area, which is not described in detail here.

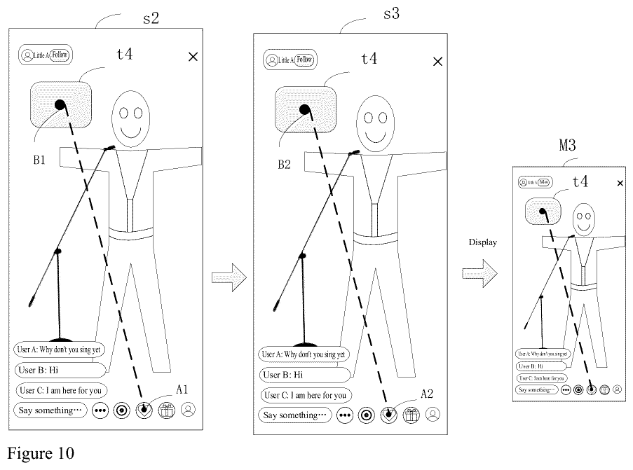

For example, referring to FIG. 10, when a target reference object in a live streaming associated frame s2 is a “favorite” control, a point A1 on the “favorite” control is determined as an origin of coordinates, a coordinate system is constructed based on the point A1, and coordinates of a center point B1 of a sticker image t4 relative to A1 are determined as the relative position information. Further, after a viewing associated frame s3 is determined, and the “favorite” control is identified, a point A2 on the “favorite” control is determined as an origin of coordinates, and a coordinate system that is the same as that in the live streaming associated frame is constructed based on the point A2, so as to determine a point B2 which has coordinates relative to the A2 as the relative position information, as display position information of the center point of the sticker image t4.

In order to further restore the display effect of the sticker image on a live streaming client, display size information of the sticker image may also be restored on the viewing client. In this embodiment, if the sticker addition message further includes fourth display size information of the sticker image, size information of the sticker image may be adjusted based on the fourth display size information.

In some embodiments, the fourth display size information is the same as the second display size information.

In some embodiments, if the fourth display size information is display size information in the live streaming associated frame and since the live streaming associated frame and the viewing associated frame have a same size, but the size information of the sticker image obtained directly based on the URL is not the same as the fourth size information, then the size of sticker image may be adjusted directly to the fourth size information. In this embodiment, if a size of a display area M3 of the viewing associated frame is different from a size of a display area of the live streaming associated frame, isometric scaling of the sticker image of the fourth size information may be performed based on a ratio between the two display areas, and after the isometric scaling is performed, an isometrically scaling sticker image is displayed as a layer, etc., at the display position information in the corresponding viewing associated frame, which therefore achieves a uniform display size of the sticker image in the viewing associated frame and the live streaming associated frame.

In conclusion, according to the image processing method in this embodiment of the present disclosure, in response to the sticker addition message sent by the server, the associated frame identifier, the URL and the display position information are extracted from the sticker addition message, and further, the sticker image is obtained based on the URL, the corresponding viewing associated frame in the viewing video stream is determined based on the associated frame identifier, and the sticker image is displayed in the corresponding viewing associated frame based on the display position information. Therefore, the sticker image that is added to the live streaming room is obtained based on the uniform resource locator (URL), without a need for fusion calculations of related live streaming video frames and the sticker image, which ensures the smoothness of live streaming, and improves the display consistency of the sticker image between the viewing client and the live streaming client.

FIG. 11 is a schematic diagram of a structure of an image processing apparatus according to an embodiment of the present disclosure. The apparatus may be implemented by software and/or hardware, and may generally be integrated into an electronic device. As shown in FIG. 11. the apparatus includes: a first obtaining module 1110, a second obtaining module 1120, a first determining module 1130, and a sending module 1140, where
the first obtaining module 1110 is configured to obtain, in response to an operation of adding a sticker image on a live streaming client, a uniform resource locator (URL) corresponding to the sticker image;
the second obtaining module 1120 is configured to determine a live streaming associated frame of the sticker image in a corresponding live video stream, and obtain an associated frame identifier of the live streaming associated frame;
the first determining module 1130 is configured to determine display position information of the sticker image in the live streaming associated frame; and
the sending module 1140 is configured to send a sticker addition message to at least one viewing client corresponding to the live streaming client, where the sticker addition message includes the associated frame identifier, the URL, and the display position information.

The image processing apparatus provided in this embodiment of the present disclosure can perform the image processing method provided in any embodiment of the present disclosure, and has corresponding functional modules and beneficial effects for performing the method.

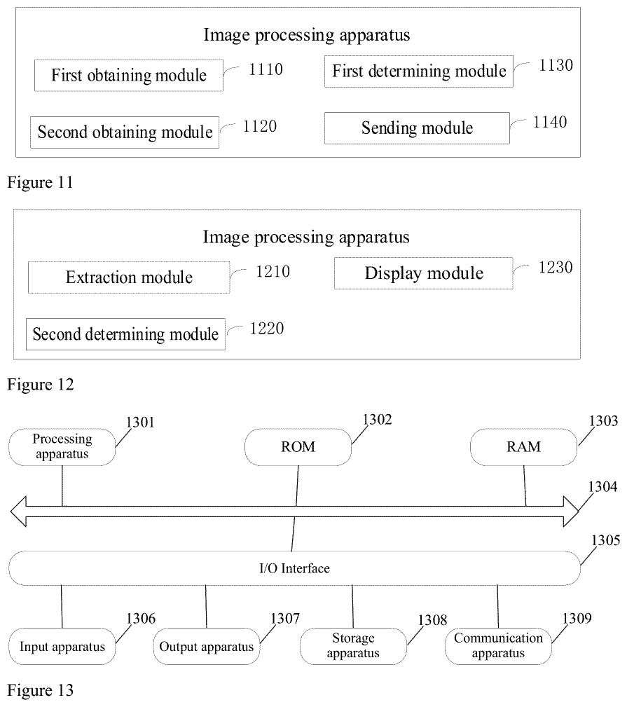

FIG. 12 is a schematic diagram of a structure of an image processing apparatus according to an embodiment of the present disclosure. The apparatus may be implemented by software and/or hardware, and may generally be integrated into an electronic device. As shown in FIG. 12. the apparatus includes: an extraction module 1210, a second determining module 1220, and a display module 1230, where
the extraction module 1210 is configured to extract, in response to a sticker addition message sent by a server, an associated frame identifier, a URL, and display position information in the sticker addition message;
the second determining module 1220 is configured to obtain a sticker image based on the URL, and determine a corresponding viewing associated frame in a viewing video stream based on the associated frame identifier; and
the display module 1230 is configured to display the sticker image in the viewing associated frame based on the display position information.

The image processing apparatus provided in this embodiment of the present disclosure can perform the image processing method provided in any embodiment of the present disclosure, and has corresponding functional modules and beneficial effects for performing the method.

The above modules may be implemented as a software component executed on one or more general-purpose processors, or may be implemented as, for example, hardware that performs certain functions or combinations thereof, such as a programmable logic device and/or an application-specific integrated circuit. In some embodiments, these modules may be embodied in the form of a software product that may be stored in non-volatile storage media that include a computer device (e.g., a personal computer, a server, a network device, a mobile terminal, or the like) caused to implement the method described in the embodiments of the present disclosure. In some other embodiments, the above modules may also be implemented on a single device or may be distributed across a plurality of devices. The functions of these modules may be combined with each other or further split into a plurality of sub-modules.

In order to implement the above embodiments, the present disclosure further provides a computer program product, including a computer program/instructions that, when executed by a processor, implements/implement the image processing method in the above embodiments.

FIG. 13 is a schematic diagram of a structure of an electronic device according to an embodiment of the present disclosure.

Reference is made specifically to FIG. 13 below, which is a schematic diagram of a structure of an electronic device 1300 suitable for implementing the embodiments of the present disclosure. The electronic device 1300 in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 13 is merely an example, and shall not impose any limitation on the function and scope of use of the embodiments of the present disclosure.

As shown in FIG. 13, the electronic device 1300 may include a processing apparatus (e.g., a central processing unit, a graphics processing unit, etc.) 1301 that may perform a variety of appropriate actions and processing in accordance with a program stored in a read-only memory (ROM) 1302 or a program loaded from a storage apparatus 1308 into a random access memory (RAM) 1303. The RAM 1303 further stores various programs and data required for the operation of the electronic device 1300. The processing apparatus 1301, the ROM 1302, and the RAM 1303 are connected to each other through a bus 1304. An input/output (I/O) interface 1305 is also connected to the bus 1304.

Generally, the following apparatuses may be connected to the I/O interface 1305: an input apparatus 1306 including, for example, a touch screen, a touchpad, a keyboard, a mouse, a camera, a microphone, an accelerometer, and a gyroscope; an output apparatus 1307 including, for example, a liquid crystal display (LCD), a speaker, and a vibrator; a storage apparatus 1308 including, for example, a tape and a hard disk; and a communication apparatus 1309. The communication apparatus 1309 may allow the electronic device 1300 to perform wireless or wired communication with other devices to exchange data. Although FIG. 13 shows the electronic device 1300 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 1309 and installed, installed from the storage apparatus 1308, or installed from the ROM 1302. The computer program, when executed by the processing apparatus 1301, causes the above-mentioned functions defined in the image processing method according to the embodiments of the present disclosure to be performed.

It should be noted that the above computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server can communicate using any currently known or future-developed network protocol such as a Hypertext Transfer Protocol (HTTP), and can be connected to digital data communication (for example, communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: in response to an operation of adding a sticker image on a live streaming client, obtain a uniform resource locator (URL) corresponding to the sticker image, determine a live streaming associated frame of the sticker image in a corresponding live video stream, obtain an associated frame identifier of the live streaming associated frame, determine display position information of the sticker image in the live streaming associated frame, and further send the sticker addition message to at least one viewing client corresponding to a live streaming client, where the sticker addition message includes the associated frame identifier, the URL, and the display position information. Therefore, the sticker image added to the live streaming room is transmitted based on the uniform resource locator (URL), without a need for fusion calculations of related live streaming video frames and the sticker image, which ensures the smoothness of live streaming, and improves the transmission efficiency of the sticker image.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to a computer of a user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. The name of a unit does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC) system, a complex programmable logic device (CPLD), and the like.

In the context of the present disclosure, a machine-readable medium may be a tangible medium that may contain or store a program used by or in combination with an instruction execution system, apparatus, or device. A machine-readable medium may be a machine-readable signal medium or a machine-readable storage medium. A machine-readable medium may include, but is not limited to, electronic, magnetic, optical, electromagnetic, infrared, or semiconductor systems, apparatus, or devices, or any suitable combination thereof. More specific examples of a machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. An image processing method, applied to a first client, comprising:
obtaining, in response to an operation of adding a sticker image, a uniform resource locator (URL) corresponding to the sticker image;
determining a target frame corresponding to the sticker image in a live video stream;
obtaining a target frame identifier of the target frame;
determining display information of the sticker image in the target frame; and
sending a sticker addition information, wherein the sticker addition information comprises the target frame identifier, the URL, and the display information.

2. The image processing method according to claim 1, wherein the determining a target frame corresponding to the sticker image in a live video stream comprises:
detecting whether each live streaming video frame in the live video stream contains the sticker image; and
in response to that a live streaming video frame contains the sticker image, determining the live streaming video frame as the target frame.

3. The image processing method according to claim 1, wherein the display information comprises the display position information, and the determining display information of the sticker image in the target frame comprises:
determining first display coordinate information of the sticker image in a live streaming video display area of the frame;
determining first display size information of the live streaming video display area;
determining coordinate proportion information based on the first display coordinate information and the first display size information; and
determining the display position information based on the coordinate proportion information.

4. The image processing method according to claim 1, wherein the display information comprises the display position information, and the determining position information of the sticker image in the target frame comprises:
identifying a target reference identifier area in the target frame that meets a preset selection condition; and
determining relative position information of the sticker image relative to the target reference identifier area as the display position information.

5. The image processing method according to claim 1, further comprising:
before sending the sticker addition information, obtaining second display size information of the sticker image in the target frame; and
updating the sticker addition information based on the second display size information.

6. An image processing method, comprising:
extracting, in response to a sticker addition information sent by a server, an target frame identifier, a URL, and display information from the sticker addition message information;
obtaining a sticker image based on the URL, and determining a target frame in a viewing video stream based on the target frame identifier; and
displaying the sticker image in the target frame based on the display information.

7. The image processing method according to claim 6, wherein the determining a target frame based on the target frame identifier comprises:
obtaining a viewing video frame identifier of each viewing video frame in the viewing video stream; and
performing matching between the target frame identifier and the viewing video frame identifier, and determining a successfully matched viewing video frame as the target frame.

8. The image processing method according to claim 6, wherein the display information comprises the display position information, and the adding the sticker image to the target frame based on the display information comprises:
in response to that the display position information comprises coordinate proportion information between coordinates of the sticker image and a size of a corresponding live streaming video display area, obtaining third display size information of a viewing video display area corresponding to the target frame;
determining second display coordinate information based on the third display size information and the coordinate proportion information; and
displaying the sticker image in the target frame based on the second display coordinate information.

9. The image processing method according to claim 8, wherein the coordinate proportion information is determined based on first display coordinate information of the sticker image in a live streaming video display area of a target frame and first display size information of a live streaming video display area of a live streaming client.

10. The image processing method according to claim 6, wherein the display information comprises the display position information, and the adding the sticker image to the target frame based on the display information comprises:
in response to that the display position information comprises relative position information of the sticker image relative to a target reference identifier area in a target frame, identifying the target reference identifier area in the viewing video frame; and
displaying the sticker image in the target frame based on the relative position information and the target reference identifier area in the viewing video frame.

11. The image processing method according to claim 6, further comprising:
in response to that the sticker addition information further comprises fourth display size information of the sticker image, before the displaying the display information of the sticker image in the target frame based on the display information, adjusting size information of the sticker image based on the fourth display size information.

12. The image processing method according to claim 11, wherein the fourth display size information is display size information of the sticker image in the target frame.

13-14. (canceled)

15. An electronic device, comprising:
a processor; and
a memory configured to store instructions executable by the processor, wherein the processor is configured to read the executable instructions from the memory, and execute the executable instructions to implement an image processing method comprising:
obtaining, in response to an operation of adding a sticker image, a uniform resource locator (URL) corresponding to the sticker image;
determining a target frame corresponding to the sticker image in a live video stream;
obtaining a target frame identifier of the target frame;
determining display information of the sticker image in the target frame; and
sending a sticker addition information, wherein the sticker addition information comprises the target frame identifier, the URL, and the display information.

16. A non-transitory computer-readable storage medium having a computer program stored thereon, wherein the computer program is configured to perform an image processing method comprising:
obtaining, in response to an operation of adding a sticker image, a uniform resource locator (URL) corresponding to the sticker image;
determining a target frame corresponding to the sticker image in a live video stream;
obtaining a target frame identifier of the target frame;
determining display information of the sticker image in the target frame; and
sending a sticker addition information, wherein the sticker addition information comprises the target frame identifier, the URL, and the display information.

17-18. (canceled)

19. The electronic device according to claim 15, wherein the determining a target frame corresponding to the sticker image in a live video stream comprises:
detecting whether each live streaming video frame in the live video stream contains the sticker image; and
in response to that a live streaming video frame contains the sticker image, determining the live streaming video frame as the target frame.

20. The electronic device according to claim 15, wherein the display information comprises the display position information, and the determining display information of the sticker image in the target frame comprises:
determining first display coordinate information of the sticker image in a live streaming video display area of the target frame;
determining first display size information of the live streaming video display area;
determining coordinate proportion information based on the first display coordinate information and the first display size information; and
determining the display position information based on the coordinate proportion information.

21. The non-transitory computer-readable storage medium according to claim 16, wherein the display information comprises the display position information, and the determining display information of the sticker image in the target frame comprises:
identifying a target reference identifier area in the target frame that meets a preset selection condition; and
determining relative position information of the sticker image relative to the target reference identifier area as the display position information.

22. The non-transitory computer-readable storage medium according to claim 16, wherein the determining a target frame corresponding to the sticker image in a live video stream comprises:
detecting whether each live streaming video frame in the live video stream contains the sticker image; and
in response to that a live streaming video frame contains the sticker image, determining the live streaming video frame as the target frame.

23. The non-transitory computer-readable storage medium according to claim 16, wherein the display information comprises the display position information, and the determining display information of the sticker image in the target frame comprises:
determining first display coordinate information of the sticker image in a live streaming video display area of the target frame;
determining first display size information of the live streaming video display area;
determining coordinate proportion information based on the first display coordinate information and the first display size information; and
determining the display position information based on the coordinate proportion information.

24. The image processing method according to claim 1, wherein the sending a sticker addition information comprises:
sending the sticker addition information to a server, which forwards the sticker addition information to a second client for displaying the sticker image.
